(19) United States
(12) Patent Application Publication
(10) Pub. No.: US 2006/0121225 A1
(43) Pub. Date: Jun. 8, 2006

(54) Adhesive

(75) Inventors: William A. Lees, Romsey (GB); Richard J. Moulds, Southampton (GB)

Correspondence Address: NIXON & VANDERHYE, PC, 901 NORTH GLEBE ROAD, 11TH FLOOR, ARLINGTON, VA, 22203, US

(73) Assignee: National Starch and Chemical Limited, Berkshire (GB)

(21) Appl. No.: 11/331,002

(22) Filed: Jan. 13, 2006

Related U.S. Application Data
(62) Division of application No. 10/453,939, filed on Jun. 4, 2003, now abandoned.
Application No. 10/453,939 is a continuation of application No. 09/621,551, filed on Jul. 21, 2000, now abandoned.
Application No. 09/621,551 is a continuation of application No. 09/029,883, filed on Apr. 8, 1998, now abandoned.

(30) Foreign Application Priority Data
Nov. 26, 1996 (GB) 9624618.6

(51) Int. Cl. B32B 27/08

(52) U.S. Cl. 428/35.7; 428/34.1

(57) ABSTRACT

An adhesive formulated from one or more organic components that have FDA approval for resinous and polymeric coating used as a food-contact surface is provided, wherein the adhesive is in accordance with the definition of “adhesive” presented in the February 1996 version of the draft European standard booklet EN 923:199X as compiled by the European Committee for Standardisation.

The present application is a divisional of application Ser. No. 10/453,939, filed Jun. 4, 2003 (pending), which is a continuation of application Ser. No. 09/621,551, filed Jul. 21, 2000 (abandoned), which is a continuation of application Ser. No. 09/029,883, filed Apr. 8, 1998 (abandoned), which is a 371 of PCT/GB97/03226, filed Nov. 25, 1997, the entire contents of each of which are incorporated herein by reference.

The present invention relates to an adhesive.

It is known to use adhesives to prepare containers for foodstuffs, such as foods and beverages. For example, it is known to use an adhesive to adhere a coated aluminium pressurised gas container to the inner surface of the base of a can, especially when that can is for containing beer. Pressurised gas containers are generically called “widgets”. Teachings on widgets may be found in British patent application No. 90/06731.7.

Another example of the use of adhesives in preparing containers for foodstuffs may be found in U.S. Pat. No. 5,370,941 which describes a laminated film comprising a base resin layer, a barrier layer and an adhesive layer. The adhesive layer is made from a blend of ethylene, alkyl (meth)acrylate, a copolymer of propylene and ethylene, and other ethylene impact copolymers.

We now recognise that some adhesive components may leak into, and thereby contaminate, foodstuffs contained in containers. This, in turn, could make the foodstuffs unpalatable or, just as importantly, not suitable for consumption, in particular human consumption.

The present invention seeks to overcome this problem.

According to a first aspect of the present invention there is provided an adhesive formulated from one or more organic components that have FDA approval.

According to a second aspect of the present invention there is provided a container for a foodstuff comprising at least two parts joined together by an adhesive, wherein the adhesive is formulated from one or more organic components having FDA approval.

Some or all of the at least two parts may be parts of a common single body or different bodies. Some or all of the at least two parts may be edges of a common single body, for example the edges of a container, preferably a can.

According to a third aspect of the present invention there is provided a container for a foodstuff having held inside a body, wherein the body is adhered to at least a part of at least one inner wall of the container by an adhesive, wherein the adhesive is formulated from one or more organic components having FDA approval.

The adhesives of the present invention are advantageous in that any leakage of the adhesive component(s) into the foodstuff contained in the container would not make the foodstuff unsuitable for consumption, in particular human consumption.

Thus, the present invention is based on the surprising finding that it is possible to formulate an adhesive composition for use in preparing a container for foodstuffs (such as a beverage) wherein the adhesive is formulated from organic components that have FDA approval.

The term “that have FDA approval” means that the components do have or can have or would have (such as in the future) FDA approval.

The term “wall” includes any side wall, base portion or top portion.

The adhesive composition of the present invention is an adhesive in that it is a non-metallic substance capable of joining materials by surface bonding (cohesion) and the bond possessing adequate internal strength adhesion. This definition is in accordance with the definition of “adhesive” presented in the February 1996 version of the draft European standard booklet EN 923:199X as compiled by the European Committee for Standardisation.

The adhesive composition does not primarily serve as a functional barrier between food and a substrate.

The adhesive is formulated solely from one or more organic components that have FDA approval. This means that the adhesive does not contain organic components that do not have FDA approval.

Preferably, the adhesive further comprises one or more inorganic inert filler components. These inert filler components may have FDA approval.

In a highly preferred embodiment, the adhesive is not water soluble.

The adhesive compositions can be tailored to cure as quickly or slowly as desired, such as by the addition of suitable and acceptable catalysts etc. or even varying the temperature of application and/or for curing.

In a preferred embodiment, the adhesive of the present invention is applied as a bead—which may be in the form of a beaded line of adhesive. This beaded line may be straight, kinked or circular—depending on what substrates the adhesive is meant to bond.

Preferably, the adhesive is formulated from at least two or more organic components that have FDA approval.

Each of the organic components of the adhesive according to the present invention is mentioned in the FDA listings as issued by the respective US Government Department—namely the Food And Drug Administration. A suitable and preferred list is presented in Section 17.300-21 CFR Ch (Apr. 1, 1995 Edition) pages 146—Section 175-153. This list is shown in the Appendix presented below.

Suitable adhesive formulations may be prepared from one or more of an epoxy organic component and/or one or more of a polyamine organic component and/or one or more of a triethylene tetra-amine component; wherein each component has FDA approval.

Preferably, the adhesive formulations is prepared from one or more of a polyamine organic component and one or more of a triethylene tetra-amine component, and optionally one or more of an epoxy organic component; wherein each component has FDA approval.

The adhesive may be a one part formulation or a multi-part formulation. Preferably, the adhesive is a two-part formulation. Thus, in one preferred embodiment the adhesive system may be a 1:1 adhesive system comprising one or more of a polyamine organic component.

The term “formulated from one or more components that have FDA approval” includes adhesives comprising or made from one or more organic components that have FDA approval.

Preferably, the adhesive formulations are prepared by blending two or more organic components having FDA approval. The order of preparing the adhesive formulation will be apparent to those skilled in the art.

The adhesive can be any one or more of an aerobic adhesive (i.e. sets in the presence of oxygen), an anaerobic adhesive (i.e. sets in the absence of oxygen), a pressure adhesive (i.e. sets on the application of a force), and a light curable adhesive (i.e. sets on exposure to a light source, such as UV light) or an adhesive that sets by a chemical reaction.

For some applications, preferably the adhesive is not a hot melt adhesive.

For some applications, preferably the adhesive is not a pressure sensitive adhesive.

Preferably the body is non-metallic.

Preferably the body is formed of a plastics material.

Preferably the body is formed of polypropylene. Alternatively, the body may be formed of polyethylene, nylon, PET (poly(ethyleneterephthalate)), polysulphone, polycarbonate or acetal.

Preferably the polypropylene has been pre-treated by any one of flame, corona discharge or plasma discharge.

Preferably the body is shaped to contain therein a pressurised gas at some stage for use.

Preferably the body contains therein a pressurised gas.

Preferably the body is for use as a widget.

Preferably the body is in use as a widget.

Preferably the container is a can.

Preferably the container is for a foodstuff.

Preferably the foodstuff is a beverage.

Preferably the beverage is a beer.

Preferably the beverage is an alcoholic beverage.

Preferably the adhesive comprises particles having an average particle size of no greater than 50 μm.

Preferably the adhesive comprises particles having a particle size of no greater than 50 μm.

Preferably the adhesive comprises no particles having a particle size of greater than 50 μm.

Preferably the adhesive sets (e.g. cures) at a temperature of between about 35° C. and about 200° C.

Preferably the adhesive sets (e.g. cures) at a temperature of between about 35° C. and about 160° C.

Preferably the adhesive sets (e.g. cures) at a temperature of between about 60° C. and about 100° C.

Preferably, the application and adhesion process occurs at a temperature of less than about 120° C. This is particularly preferred when a plastics body is fitted and bonded to the inside of a coated aluminium can.

Advantages of the adhesive of the present invention include: ease of formulation; ease of storage; ease of handling; ease of application; the ability to prevent substantial relative movement of the two substrates that are to be bonded upon curing of the adhesive; the ability to anchor a body within a container before bonding the body to the inside of the container upon the cure of the adhesive; flow readily at the application temperature; bond a number of substrates; meet the FDA regulations for food and beverage contact; set fairly quickly; and retain adequate strength for at least two years.

The adhesive can be a one part formulation—e.g. the adhesive is ready to apply without the need to mix with another component. Alternatively, the formulation can be formed from at least two parts—e.g. the final adhesive formulation is formed by mixing two formulations (each of which is formulated from one or more organic components that have FDA approval) prior to application. Preferably, for some applications the adhesive is a two part formulation. However, for ease of use, it is highly preferred that for some applications the adhesive is a one part formulation.

According to a preferred aspect of the present invention there is provided a container for a foodstuff having held in the inside thereof a body, wherein the body is adhered to at least a part of at least one inner wall of the container by an adhesive, wherein the adhesive is formulated from one or more organic components having FDA approval; wherein the body is formed of a plastics material; wherein the body is shaped to contain therein a pressurised gas; wherein the foodstuff is a beverage; and wherein the adhesive sets at a temperature of between about 35° C. and about 200° C.

According to a preferred aspect of the present invention there is provided a container for a foodstuff having held in the inside thereof a body, wherein the body is adhered to at least a part of at least one inner wall of the container by an adhesive, wherein the adhesive is formulated from one or more organic components having FDA approval; wherein the body is formed of a plastics material; wherein the body is shaped to contain therein a pressurised gas; wherein the foodstuff is a beverage; and wherein the adhesive sets at a temperature of between about 35° C. and about 160° C.

According to a highly aspect of the present invention there is provided a container for a foodstuff having held in the inside thereof a body, wherein the body is adhered to at least a part of at least one inner wall of the container by an adhesive, wherein the adhesive is formulated from one or more organic components having FDA approval; wherein the body is formed of polypropylene; wherein the body is shaped to contain therein a pressurised gas; wherein the foodstuff is a beverage; and wherein the adhesive sets at a temperature of between about 60° C. and about 100° C.

According to a more highly aspect of the present invention there is provided a container for a foodstuff having held in the inside thereof a body, wherein the body is adhered to at least a part of at least one inner wall of the container by an adhesive, wherein the adhesive is formulated from one or more organic components having FDA approval; wherein the body is formed of polypropylene; wherein the body is shaped to contain therein a pressurised gas; wherein the foodstuff is a beverage; wherein the adhesive sets at a temperature of between about 60° C. and about 100° C.; and wherein the adhesive is formulated from one or more of an epoxy organic component and/or one or more of a polyamine organic component and/or one or more of a triethylene tetra-amine component.

The present invention will now be described only by way of example.

Two adhesives according to the present invention were used individually to adhere a treated plastics structure (such as polypropylene or nylon) for use as a widget (i.e. for use as a pressurised gas container) to the inner surface of the base of a coated aluminium can for containing a beverage, such as a beer. The treated plastics structure was formed by subjecting an untreated plastics structure to any one or flame, corona discharge or plasma discharge (corona discharge under vacuum).

The formulation of the adhesives were as follows:

FORMULATION 1

| | % wt | % wt of total |
|---|---|---|
| | of component | formulation |
| FIRST COMPONENT (RESIN) | | |
| Isopropylidenediphenol-epichlorohydrin | 28.2 | 20 |
| Calcium carbonate | 56.3 | 40 |
| Phenolnovolak-epichlorohydrin | 14.1 | 10 |
| Titanium dioxide | 1.4 | 1 |
| SECOND COMPONENT (HARDENER) | | |
| Polyamide (dimerised vegetable oil) | 86.3 | 25 |
| Fumed silica | 6.9 | 2 |
| Triethylenetetramine | 3.4 | 1 |
| Polyethylene glycol | 3.4 | 1 |

Curing Conditions: 5 minutes at 100° C.

The amount of the first or second component, or any of the constituents thereof, may be varied ±30% with respect to the amounts given above.

Surprisingly, this adhesive adhered the plastics structures (especially the polypropylene structure and the nylon structure) to the inner surface of the base of the can.

FORMULATION 2

| | % wt |
|---|---|
| Isopropylidenediphenol-epichlorohydrin | 60 |
| Cyanoguanidine | 6 |
| Calcium carbonate | 30 |
| Fumed silica | 2 |
| Carbon | 1 |
| Polyethylene glycol | 1 |

Curing Conditions: 15 minutes at 180° C.
or: 1 hour at 140° C.

Surprisingly, this adhesive adhered the plastics structures (especially the nylon structure at the shorter cure time and the polypropylene structure at the longer cure time) to the inner surface of the base of the can.

Modifications to the present invention will be apparent to those skilled in the art.

### APPENDIX

### FDA List

Section 175.300 Resinous and Polymeric Coatings.

Resinous and polymeric coatings may be safely used as the food-contact surface of articles intended for use in producing, manufacturing, packing, processing, preparing, treating, packaging, transporting, or holding food, in accordance with the following prescribed conditions:

(a) The coating is applied as a continuous film or enamel over a metal substrate, or the coating is intended for repeated food-contact use and is applied to any suitable substrate as a continuous film or enamel that serves as a functional barrier between the food and the substrate. The coating is characterized by one or more of the following descriptions:

(1) Coatings cured by oxidation.

(2) Coatings cured by polymerization, condensation, and/or cross-linking without oxidation.

(3) Coatings prepared from prepolymerized substances.

(b) The coatings are formulated from optional substances that may include:

(1) Substances generally recognized as safe in food.

(2) Substances the use of which is permitted by regulations in this part or which are permitted by prior sanction or approval and employed under the specific conditions, if any, of the prior sanction or approval.

(3) Any substance employed in the production of resinous and polymeric coatings that is the subject of a regulation in subchapter B of this chapter and conforms with any specification in such regulation. Substances named in this paragraph (b)(3) and further identified as required:

(i) Drying oils, including the triglycerides or fatty acids derived

therefrom:

Beechnut.

Candlenut.

Castor (including dehydrated).

Chinawood (tung).

Coconut.

Corn.

Cottonseed.

Fish (refined).

Hempseed.

Linseed.

Oiticica.

Perilla.

Poppyseed.

Pumpkinseed.

Safflower.

Sesame.

Soybean.

Sunflower.

Tall oil.

Walnut.

The oils may be raw, heat-bodied, or blown. They may be refined by filtration, degumming, acid or alkali washing, bleaching, distillation, partial dehydration; partial polymerization, or solvent extraction, or modified by combination with maleic anhydride.

(ii) Reconstituted oils from triglycerides or fatty acids derived from the oils listed in paragraph (b)(3)(i) of this section to form esters with:

Butylene glycol.

Ethylene glycol.

Pentaerythritol.

Polyethylene glycol.

Polypropylene glycol.

Propylene glycol.

Sorbitol.

Trimethylol ethane.

Trimethylol propane.

(iii) Synthetic drying oils, as the basic polymer:

Butadiene and methylstyrene copolymer.

Butadiene and styrene copolymer, blown or unblown.

Maleic anhydride adduct of butadiene styrene.

Polybutadiene.

(iv) Natural fossil resins, as the basic resin:

Copal.

Damar.

Elemi.

Gilsonite.

Glycerol ester of damar, copal, elemi, and sandarac.

Sandarac.

Shellac.

Utah coal resin.

(v) Rosins and rosin derivatives, with or without modification by polymerization, isomerization, incidental decarboxylation, and/or hydrogenation, as follows:

(a) Rosins, refined to color grade of K or paler:

Gum rosin.

Tall oil rosin.

Wood rosin.

(b) Rosin esters formed by reacting rosin (paragraph (b)(3)(v)(a) of this section) with:

4,4′-sec-Butylidenediphenol-epichlorohydrin (epoxy).

Diethylene glycol.

Ethylene glycol.

Glycerol.

4,4′-Isopropylidenediphenol-epichlorohydrin (epoxy).

Methyl alcohol.

Pentaerythritol.

(c) Rosin esters (paragraph (b)(3)(v)(b) of this section) modified by reaction with:

Maleic anhydride.

o-, m-, and p-substituted phenol-formaldehydes listed in paragraph (b)(3)(vi) of this section.

Phenol-formaldehyde.

(d) Rosin salts:

Calcium resinate (limed rosin).

Zinc resinate.

(vi) Phenolic resins as the basic polymer formed by reaction of phenols with formaldehyde:

(a) Phenolic resins formed by reaction of formaldehyde with:

Alkylated (methyl, ethyl, propyl, isopropyl, butyl) phenols.

p-tert-Amylphenol.

4,4′-sec-Butylidenediphenol.

p-tert-Butylphenol.

o-, m-, and p-Cresol.

p-Cyclohexylphenol.

4,4′-Isopropylidenediphenol.

p-Nonylphenol.

p-Octylphenol.

3-Pentadecyl phenol mixture obtained from cashew nut shell liquid.

Phenol.

Phenyl o-cresol.

p-Phenylphenol.

Xylenol.

(b) Adjunct for phenolic resins: Aluminum butylate.

(vii) Polyester resins (including alkyd-type), as the basic polymers, formed as esters of acids listed in paragraph (b)(3)(vii) (a) and (b) of this section by reaction with alcohols in paragraph (b)(3)(vii) (c) and (d) of this section.

(a) Polybasic acids:

Adipic.

Dimerized fatty acids derived from oils listed in paragraph (b)(3)(i) of this section.

Fumaric.

Isophthalic.

Maleic.

Orthophthalic.

Sebacic.

Terephthalic.

Terpene-maleic acid adduct.

Trimellitic.

(b) Monobasic acids:

Benzoic acid.

4,4-Bis(4′-hydroxyphenyl)-pentanoic acid.

tert-Butyl benzoic acid.

Fatty acids derived from oils listed in paragraph (b)(3)(i) of this section.

Rosins listed in paragraph (b)(3)(v)(a) of this section, for use only as reactants in oil-based or fatty acid-based alkyd resins.

(c) Polyhydric alcohols:

Butylene glycol.

Diethylene glycol.

2,2-Dimethyl-1,3-propanediol for use only in forming polyester resins for coatings intended for use in contact with non-alcoholic foods.

Ethylene glycol.

Glycerol.

Mannitol.

α-Methyl glucoside.

Pentaerythritol.

Propylene glycol.

Sorbitol.

Triethylene glycol, for use as a component in polyester resins for coatings not exceeding a coating weight of 4 milligrams per square inch and that are intended for contact under conditions of use D, E, F or G described in table 2 of paragraph (d) of this section with alcoholic beverages containing less than 8 percent alcohol.

Trimethylol ethane.

Trimethylol propane.

(d) Monohydric alcohols:

Cetyl alcohol.

Decyl alcohol.

Lauryl alcohol.

Myristyl alcohol.

Octyl alcohol.

Stearyl alcohol.

(e) Catalysts:

Dibutyltin oxide (CAS Reg. No. 818-08-6), not to exceed 0.2 percent of the polyester resin.

Hydroxybutyltin oxide (CAS Reg. No. 2273-43-0), not to exceed 0.2 percent of the polyester resin.

Monobutyltin tris(2-ethylhexoate) (CAS Reg. No. 23850-944), not to exceed 0.2 percent of the polyester resin.

(viii) Epoxy resins, catalysts, and adjuncts:

(a) Epoxy resins, as the basic polymer:

(Alkoxy C₁₀-C₁₆)-2,3-epoxypropane, in which the alkyl groups are even numbered and consist of a maximum of 1 percent C₁₀carbon atoms and a minimum of 48 percent C₁₂ carbon atoms and a minimum of 18 percent C₁₄ carbon atoms, for use only in coatings that are intended for contact with dry bulk foods at room temperature.

4,4′-sec-Butylidenediphenol-epichlorohydrin.

4,4′-sec-Butylidenediphenol-epichlorohydrin reacted with one or more of the drying oils or fatty acids listed in paragraph (b)(3)(i) of this section.

4,4′-sec-Butylidenediphenol-epichlorohydrin chemically treated with one or more of the following substances:

Allyl ether of mono-, di-, or trimethylol phenol.

4,4′-sec-Butylidenediphenol-formaldehyde.

4,4′-Isopropylidenediphenol-formaldehyde.

Melamine-formaldehyde.

Phenol-formaldehyde.

Urea-formaldehyde.

Epoxidized polybutadiene.

Glycidyl ethers formed by reacting phenolnovolak resins with epichlorohydrin.

4,4′-Isopropylidenediphenol-epichlorohydrin.

4,4′-Isopropylidenediphenol-epichlorohydrin reacted with one or more of the drying oils or fatty acids listed in paragraph (b)(3)(i) of this section.

4,4′-Isopropylidenediphenol-epichlorohydrin chemically treated with one or more of the following substances:

Allyl ether of mono-, di-, or trimethylol phenol.

4,4′-sec-Butylidenediphenol-formaldehyde.

4,4′-Isopropylidenediphenol-formaldehyde.

Melamine-formaldehyde.

Phenol-formaldehyde.

Urea-formaldehyde.

(b) Catalysts and cross-linking agents for epoxy resins:

3-(Aminomethyl)-3,5,5-trimethylcyclohexylamine reacted with phenol and formaldehyde in a ratio of 2.6:1.0:2.0, for use only in coatings intended for repeated use in contact with foods only of the types identified in paragraph (d) of this section, table 1, under Category I and Category VIII, at temperatures not exceeding 88 deg.C. (190 deg.F.).

Cyanoguanidine.

Dibutyl phthalate, for use only in coatings for containers having a capacity of 1,000 gallons or more when such containers are intended for repeated use in contact with alcoholic beverages containing up to 8 percent of alcohol by volume.

Diethylenetriamine.

Diphenylamine.

Ethylenediamine.

Isophthalyl dihydrazide for use only in coatings subject to the provisions of paragraph (c) (3) or (4) of this section.

4,4′-Methylenedianiline, for use only in coatings for containers having a capacity of 1,000 gallons or more when such containers are intended for repeated use in contact with alcoholic beverages containing up to 8 percent of alcohol by volume.

N-Oleyl-1,3-propanediamine with not more than 10 percent by weight of diethylaminoethanol.

Polyamine produced when 1 mole of the chlorohydrin diether of polyethylene glycol 400 is made to react under dehydrohalogenating conditions with 2 moles of N-octadecyltrimethylenediamine for use only in coatings that are subject to the provisions of paragraph (c) (3) or (4) of this section and that contact food at temperatures not to exceed room temperature.

Salicylic acid, for use only in coatings for containers having a capacity of 1,000 gallons or more when such containers are intended for repeated use in contact with alcoholic beverages containing up to 8 percent of alcohol by volume.

Stannous 2-ethylhexanoate for use only as a catalyst at a level not to exceed 1 percent by weight of the resin used in coatings that are intended for contact with food under conditions of use D, E, F, and G described in table 2 of paragraph (d) of this section.

Styrene oxide, for use only in coatings for containers having a capacity of 1,000 gallons or more when such containers are intended for repeated use in contact with alcoholic beverages containing up to 8 percent of alcohol by volume.

Tetraethylenepentamine.

Tetraethylenepentamine reacted with equimolar quantities of fatty acids.

Tri(dimethylaminomethyl) phenol and its salts prepared from the fatty acid moieties of the salts listed in paragraph (b)(3)(xxii)(b) of this section, for use only in coatings subject to the provisions of paragraph (c) (3) or (4) of this section.

Triethylenetetramine.

Trimellitic anhydride (CAS Reg. No. 552-30-7) for use only as a cross-linking agent at a level not to exceed 15 percent by weight of the resin in contact with food under all conditions of use, except that resins intended for use with foods containing more than 8 percent alcohol must contact such food only under conditions of use D, E, F, and G described in table 2 of paragraph (d) of this section.

Trimellitic anhydride adducts of ethylene glycol and glycerol, prepared by the reaction of 1 mole of trimellitic anhydride with 0.4-0.6 mole of ethylene glycol and 0.04-0.12 mole of glycerol, for use only as a cross-linking agent at a level not to exceed 10 percent by weight of the cured coating, provided that the cured coating only contacts food containing not more than 8 percent alcohol.

(c) Adjuncts for epoxy resins:

Aluminum butylate.

Benzoic acid, for use as a component in epoxy resins for coatings not exceeding a coating weight of 4 milligrams per square inch and that are intended for contact under conditions of use D, E, F or G described in table 2 of paragraph (d) of this section with alcoholic beverages containing less than 8 percent alcohol.

Polyamides from dimerized vegetable oils and the amine catalysts listed in paragraph (b)(3)(viii)(b) of this section, as the basic polymer.

Silane coupled silica, prepared from the reaction of microcrystalline quartz with N-beta-(N-vinylbenzylamino) ethyl-gamma-aminopropyltrimethoxy silane, monohydrogen chloride, for use only in coatings intended for repeated use in contact with foods only of the types identified in paragraph (d) of this section, table 1, under Category I and Category VIII, at temperatures not exceeding 88 deg.C. (190 deg.F.).

Succinic anhydride, for use as a component in epoxy resins for coatings not exceeding a coating weight of 4 milligrams per square inch, and that are intended for contact under conditions of use D, E, F or G described in table 2 of paragraph

(d) of this section with alcoholic beverages containing less than 8 percent alcohol.

(ix) Coumarone-indene resin, as the basic polymer.

(x) Petroleum hydrocarbon resin (cyclopentadiene type), as the basic polymer.

(xi) Terpene resins, as the basic polymer, from one or more of the following:

Dipentene.

α-Pinene.

β-Pinene.

(xii) Urea-formaldehyde, resins and their curing catalyst:

(a) Urea-formaldehyde resins, as the basic polymer:

Urea-formaldehyde.

Urea-formaldehyde chemically modified with methyl, ethyl, propyl, isopropyl, butyl, or isobutyl alcohol.

Urea-formaldehyde chemically modified with one or more of the amine catalysts listed in paragraph (b)(3)(viii)(b) of this section.

(b) Curing (cross-linking) catalyst for urea-formaldehyde resins:

Dodecyl benzenesulfonic acid (C.A. Registry No. 27176-87-0).

(xiii) Triazine-formaldehyde resins and their curing catalyst:

(a) Triazine-formaldehyde resins, as the basic polymer:

Benzoguanamine-formaldehyde.

Melamine-formaldehyde.

Melamine-formaldehyde chemically modified with one or more of the following amine catalysts:

Amine catalysts listed in paragraph (b)(3)(viii)(b) of this section.

Dimethylamine-2-methyl-1-propanol.

Methylpropanolamine.

Triethanolamine.

Melamine-formaldehyde chemically modified with methyl, ethyl, propyl, isopropyl, butyl, or isobutyl alcohol.

(b) Curing (cross-linking) catalyst for triazine-formaldehyde resins:

Dodecyl benzenesulfonic acid (C.A. Registry No. 27176-87-0).

(xiv) Modifiers (for oils and alkyds, including polyesters), as the basic polymer:

Butyl methacrylate.

Cyclopentadiene.

Methyl, ethyl, butyl, or octyl esters of acrylic acid.

Methyl methacrylate.

Styrene.

Vinyl toluene.

(xv) Vinyl resinous substance, as the basic polymers:

Polyvinyl acetate.

Polyvinyl alcohol.

Polyvinyl butyral.

Polyvinyl chloride.

Polyvinyl formal.

Polyvinylidene chloride.

Polyvinyl pyrrolidone.

Polyvinyl stearate.

Vinyl chloride-acetate-2,3-epoxypropyl methacrylate copolymers containing not more than 10 weight percent of total polymer units derived from 2,3-epoxypropyl methacrylate and not more than 0.1 weight percent of unreacted 2,3-epoxypropyl methacrylate monomer for use in coatings for containers.

Vinyl chloride-acetate, hydroxyl-modified copolymer.

Vinyl chloride-acetate, hydroxyl-modified copolymer, reacted with trimellitic anhydride.

Vinyl chloride copolymerized with acrylamide and ethylene in such a manner that the finished copolymers have a minimum weight average molecular weight of 30,000 and contain not more than 3.5 weight percent of total polymer units derived from acrylamide; the acrylamide portion may or may not be subsequently partially hydrolyzed.

Vinyl chloride copolymerized with one or more of the following substances:

Acrylonitrile.

Fumaric acid and/or its methyl, ethyl, propyl, butyl, amyl, hexyl, heptyl, or octyl esters.

Maleic acid and/or its methyl, ethyl, propyl, butyl, amyl, hexyl, heptyl, or octyl esters.

5-Norbornene-2,3-dicarboxylic acid, mono-n-butyl ester; for use such that the finished vinyl chloride copolymers contain not more than 4 weight percent of total polymer units derived from this comonomer.

Vinyl acetate.

Vinylidene chloride.

Vinyl chloride-vinylidene chloride-2,3-epoxypropyl methacrylate copolymers containing not more than 10 weight percent of total polymer units derived from 2,3-epoxypropyl methacrylate and not more than 0.05 weight percent of unreacted 2,3-epoxypropyl methacrylate monomer based on polymer solids for use only in coatings for containers intended for contact with foods under conditions B, C, D, E, F, G, or H described in table 2 of paragraph (d) of this section.

(xvi) Cellulosics, as the basic polymer:

Carboxymethylcellulose.

Cellulose acetate.

Cellulose acetate-butyrate.

Cellulose acetate-propionate.

Ethylcellulose.

Ethyl hydroxyethylcellulose.

Hydroxyethylcellulose.

Hydroxypropyl methylcellulose.

Methylcellulose.

Nitrocellulose.

(xvii) Styrene polymers, as the basic polymer:

Polystyrene.

α-Methyl styrene polymer.

Styrene copolymerized with one or more of the following:

Acrylonitrile.

α-Methylstyrene.

(xviii) Polyethylene and its copolymers as the basic polymer:

Ethylene-ethyl acrylate copolymer.

Ethylene-isobutyl acrylate copolymers containing no more than 35 weight percent of total polymer units derived from isobutyl acrylate.

Ethylene-vinyl acetate copolymer.

Polyethylene.

(xix) Polypropylene as the basic polymer:

Polypropylene.

Maleic anhydride adduct of polypropylene The polypropylene used in the manufacture of the adduct complies with Sec. 177.1520(c), item 1.1; and the adduct has a maximum combined maleic anhydride content of 0.8 percent and a minimum intrinsic viscosity of 0.9, determined at 135 deg.C. on a 0.1 percent solution of the modified polypropylene in decahydronaphthalene as determined by a method titled “Method for Determination of Intrinsic Viscosity of Maleic Anhydride Adduct of Polypropylene,” which is incorporated by reference. Copies are available from the Center for Food Safety and Applied Nutrition (HFS-200), Food and Drug Administration, 200 C St. SW., Washington, D.C. 20204, or available for inspection at the Office of the Federal Register, 800 North Capitol Street, NW., suite 700, Washington, D.C. 20408.

(xx) Acrylics and their copolymers, as the basic polymer:

Acrylamide with ethylacrylate and/or styrene and/or methacrylic acid, subsequently reacted with formaldehyde and butanol.

Acrylic acid and the following esters thereof:

Ethyl.

Methyl.

Butyl acrylate-styrene-methacrylic acid-hydroxyethyl methacrylate copolymers containing no more than 20 weight percent of total polymer units derived from methacrylic acid and containing no more than 7 weight percent of total polymer units derived from hydroxyethyl methacrylate; for use only in coatings that are applied by electrodeposition to metal substrates.

Butyl acrylate-styrene-methacrylic acid-hydroxypropyl methacrylate copolymers containing no more than 20 weight percent of total polymer units derived from methacrylic acid and containing no more than 7 weight percent of total polymer units derived from hydroxypropyl methacrylate; for use only in coatings that are applied by electrodeposition to metal substrates and that are intended for contact, under condition of use D, E, F, or G described in table 2 of paragraph (d) of this section, with food containing no more than 8 percent of alcohol.

Ethyl acrylate-styrene-methacrylic acid copolymers for use only as modifiers for epoxy resins listed in paragraph (b)(3)(viii)(a) of this section.

Ethyl acrylate-methyl methacrylate-styrene-methacrylic acid copolymers for use only as modifiers for epoxy resins listed in paragraph (b)(3)(viii)(a) of this section. 2-Ethylhexyl acrylate-ethyl acrylate copolymers prepared by copolymerization of 2-ethylhexyl acrylate and ethyl acrylate in a 7/3 weight ratio and having a number average molecular weight range of 5,800 to 6,500 and a refractive index, n_{D}²⁵°, (40 percent in 2,2,4-trimethyl pentane) of 1.4130-1.4190; for use as a modifier for nylon resins complying with Sec. 177.1500 of this chapter and for phenolic and epoxy resins listed in paragraph (b)(3) (vi) and (viii) of this section, respectively, at a level not to exceed 1.5 percent of the coating.

2-Ethylhexyl acrylate-methyl methacrylate-acrylic acid copolymers for use only as modifiers for epoxy resins listed in paragraph (b)(3)(viii) of this section.

Methacrylic acid and the following esters thereof:

Butyl.

Ethyl.

Methyl.

Methacrylic acid or its ethyl and methyl esters copolymerized with one or more of the following:

Acrylic acid.

Ethyl acrylate.

Methyl acrylate.

n-Butyl acrylate-styrene-methacrylic acid-hydroxyethyl methacrylate copolymers containing no more than 2 weight percent of total polymer units derived from methacrylic acid and containing no more than 9.5 weight percent of total polymer units derived from hydroxyethyl methacrylate; for use only in coatings in contact with dry food (food type VIII in table 1 of paragraph (d) of this section). 2-(Dimethylamino) ethanol (C.A.S. Registry No. 108-01-0) may be employed as an optional adjuvant substance limited to no more than 2 weight percent based on polymer solids in the coating emulsion.

Styrene polymers made by the polymerization of any combination of styrene or alpha methyl styrene with acrylic acid, methacrylic acid, 2-ethyl hexyl acrylate, methyl methacrylate, and butyl acrylate. The styrene and alpha methyl styrene, individually, may constitute from 0 to 80 weight percent of the polymer. The other monomers, individually, may be from 0 to 40 weight percent of the polymer. The polymer number average molecular weight (Mₙ) shall be at least 2,000 (as determined by gel permeation chromatography). The acid number of the polymer shall be less than 250. The monomer content shall be less than 0.5 percent. The polymers are for use only in contact with food of Types IV-A, V, VII in table 1 of paragraph (d) of this section, under use conditions E through G in table 2 of paragraph (d), and with food of Type VIII without use temperature restriction.

(xxi) Elastomers, as the basic polymer:

Butadiene-acrylonitrile copolymer.

Butadiene-acrylonitrile-styrene copolymer.

Butadiene-styrene copolymer.

Butyl rubber.

Chlorinated rubber.

2-Chloro-1,3-butadiene (neoprene).

Natural rubber (natural latex or atural latex solids, smoked or unsmoked).

Polyisobutylene.

Rubber hydrochloride.

Styrene-isobutylene copolymer.

(xxii) Driers made by reaction of a metal from paragraph (b)(3)(xxii)(a) of this section with acid, to form the salt listed in paragraph (b)(3)(xxii)(b) of this section:

(a) Metals:

Aluminum.

Calcium.

Cerium.

Cobalt.

Iron.

Lithium.

Magnesium.

Manganese.

Zinc.

Zirconium.

(b) Salts:

Caprate.

Caprylate.

Isodecanoate.

Linoleate.

Naphthenate.

Neodecanoate.

Octoate (2-ethylhexoate).

Oleate.

Palmitate.

Resinate.

Ricinoleate.

Soyate.

Stearate.

Tallate.

(xxiii) Waxes:

Paraffin, Type I.

Paraffin. Type II.

Polyethylene.

Sperm oil.

Spermaceti.

(xxiv) Plasticizers:

Acetyl tributyl citrate.

Acetyl triethyl citrate.

Butyl phthalyl butyl glycolate.

Butyl stearate.

p-tert-Butyl phenyl salicylate.

Dibutyl sebacate.

Diethyl phthalate.

Diisobutyl adipate.

Diisooctyl phthalate.

Epoxidized soybean oil (iodine number maximum 14; oxirane oxygen content 6% minimum), as the basic polymer.

Ethyl phthalyl ethyl glycolate.

2-Ethylhexyl diphenyl phosphate.

di-2-Ethylhexyl phthalate.

Glycerol.

Glyceryl monooleate.

Glyceryl triacetate.

Monoisopropyl citrate.

Propylene glycol.

Sorbitol.

Mono-, di-, and tristearyl citrate.

Triethyl citrate.

Triethylene glycol.

3-(2-Xenolyl)-1,2-epoxypropane.

(xxv) Release agents, as the basic polymer, when applicable:

N,N′-Dioleoylethylenediamine (CAS Reg. No. 110-31-6) for use only in ionomeric resins complying with Sec. 177.1330 of this chapter and in ethylene vinyl acetate copolymers complying with Sec. 177.1350 of this chapter at a level not to exceed 0.0085 milligram per square centimeter (0.055 milligram per square inch) in the finished food-contact article.

N,N′-Distearoyl ethylenediamine.

Linoleic acid amide.

Oleic acid amide.

Palmitic acid amide.

Petrolatum.

Polyethylene wax.

Polyoxyethylene glycol monooleate (mol. wt. of the polyoxyethylene glycol moiety greater than 300).

Polytetrafluoroethylene.

Silicones (not less than 300 centistokes viscosity):

Dimethylpolysiloxanes and/or methylphenylpolysiloxanes. The methyl-phenylpolysiloxanes contain not more than 2.0 percent by weight of cyclosiloxanes having up to and including 4 siloxy units.

Silicones (not less than 100 centistokes viscosity):

Dimethylpolysiloxanes and/or methylphenylpolysiloxanes limited to use only on metal substrates. The methylphenylpolysiloxanes contain not more than 2.0 percent by weight of cyclosiloxanes having up to and including 4 siloxy units.

(xxvi) Colorants used in accordance with Sec. 178.3297 of this chapter.

(xxvii) Surface lubricants:

Cottonseed oil and other edible oils.

Dibutyl sebacate.

Dioctyl sebacate.

Glyceryl monostearate.

Lanolin.

Mineral oil, white.

Palm oil.

Paraffin, Type I.

Paraffin, Type II.

Petrolatum.

Stearic acid.

(xxviii) Silicones and their curing catalysts:

(a) Silicones as the basic polymer:

Siloxane resins originating from methyl hydrogen polysiloxane, dimethyl polysiloxane, and methylphenyl polysiloxane.

(b) Curing (cross-linking) catalysts for silicones (the maximum amount of tin catalyst used shall be that required to effect optimum cure but shall not exceed 1 part of tin per 100 parts of siloxane resins solids):

Dibutyltin dilaurate.

Stannous oleate.

Tetrabutyl titanate.

(xxix) Surface active agents:

Ethylene oxide adduct of 2,4,7,9-tetramethyl-5-decyn-4,7-diol (CAS Reg. No. 9014-85-1).

Poly[2-(diethylamino) ethyl methacrylate] phosphate (minimum intrinsic viscosity in water at 25 deg.C. is not less than 9.0 deciliters per gram as determined by ASTM method D1243-79, “Standard Test Method for Dilute Solution Viscosity of Vinyl Chloride Polymers,” which is incorporated by reference (copies may be obtained from the American Society for Testing Materials, 1916 Race St., Philadelphia, Pa. 19103, or may be examined at the Office of the Federal Register, 800 North Capitol Street, NW., suite 700, Washington, D.C. 20408), for use only as a suspending agent in the manufacture of vinyl chloride copolymers and limited to use at levels not to exceed 0.1 percent by weight of the copolymers.

Sodium dioctyl sulfosuccinate.

Sodium dodecylbenzenesulfonate

Sodium lauryl sulfate.

2,4,7,9-Tetramethyl-5-decyn-4,7-diol (C.A.S. Reg. No. 126-86-3), for use only in can coatings which are subsequently dried and cured at temperatures of at least 193 deg.C. (380 deg.F.) for 4 minutes.

(xxx) Antioxidants:

Butylated hydroxyanisole.

Butylated hydroxytoluene.

Gum guaiac.

Dilauryl thiodipropionate.

Nordihydroguaiaretic acid.

Propyl gallate.

Distearyl thiodipropionate.

Thiodipropionic acid.

2,4,5-Trihydroxybutyrophenone.

1. An adhesive formulated from one or more organic components that have FDA approval for resinous and polymeric coating used as a food-contact surface, wherein the adhesive is in accordance with the definition of “adhesive” presented in the February 1996 version of the draft European standard booklet EN 923:199X as compiled by the European Committee for Standardisation.

2. An adhesive according to claim 1, wherein the adhesive further comprises one or more inorganic inert filler components.

3. An adhesive according to claim 1, wherein the adhesive is not water soluble.

4. An adhesive according to claim 1, wherein the adhesive sets at a temperature of between about 35° C. and about 200° C.

5. An adhesive according to claim 1, wherein the adhesive sets at temperature of between 35° C. and about 160° C.

6. An adhesive according to claim 1, wherein the organic component(s) is (are) selected from the FDA approved list of compounds presented in Section 175.300-21 CFR Ch (Apr. 1, 1995 Edition).

7. A container for a foodstuff comprising at least two parts joined together by an adhesive, wherein the adhesive is an adhesive according to claim 1.

8. A container for a foodstuff having held inside a body, wherein the body is adhered to at least a part of at least one inner wall of the container by an adhesive, wherein the adhesive is an adhesive according to claim 1.

9. A container according to claim 8, wherein the body is non-metallic.

10. A container according to claim 8, wherein the body is formed of a plastics material.

11. A container according to claim 8, wherein the body is formed of polypropylene.

12. A container according to claim 11, wherein the polypropylene has been pre-treated by any one of flame, corona discharge or plasma discharge.

13. A container according to claim 8, wherein the body is for use as a widget.

14. A container according to claim 7, wherein the container is a can.

15. A container according to claim 7, wherein the container is for a beverage.

16. A container according to claim 15, wherein the beverage is an alcoholic beverage.

17. A container according to claim 15, wherein the beverage is a beer.

18. An adhesive formulated from
(i) a composition comprising isopropylidenediphenol-epicholorohydrin and phenolnovolak-epicholorohydrin
(ii) a composition comprising polyamide formed from dimerised vegetable oil, and triethylenetetramine wherein the adhesive is in accordance with the definition of “adhesive” presented in the February 1996 version of the draft European standard booklet EN 923:199X as compiled by the European Committee for Standardisation.

19. An adhesive formulated from isopropylidenediphenol-epicholohydrin and cyanoguanidine, wherein the adhesive is in accordance with the definition of “adhesive” presented in the February 1996 version of the draft European standard booklet EN 923:199X as compiled by the European Committee for Standardisation.

20. An adhesive according to claim 5, wherein the adhesive sets at a temperature of between about 60° C. and about 100° C.

21. An adhesive according to claim 1 wherein the adhesive is not a hot melt adhesive.

22. An adhesive according to claim 1 wherein the adhesive is not a pressure sensitive adhesive.

23. An adhesive according to claim 1 wherein the adhesive is a two-part formulation.

24. An adhesive according to claim 23 wherein the adhesive is a 1:1 adhesive system.

25. An adhesive according to claim 24 wherein the adhesive comprises one or more organic polyamines.

26. The adhesive according to claim 1 wherein the adhesive is a one part formulation.
